(19) United States
(12) Patent Application Publication
(10) Pub. No.: US 2011/0121478 A1
(43) Pub. Date: May 26, 2011

(54) Methods for Manufacturing Low Back Pressure Porous Cordierite Ceramic Honeycomb Articles

(76) Inventors: Douglas Munroe Beall, Painted Post, NY (US); Thomas Richard Chapman, Painted Post, NY (US); Martin Joseph Murtagh, Trumansburg, NY (US); Balaji Venkatesan Swarnamani, Painted Post, NY (US)

(21) Appl. No.: 13/017,792

(22) Filed: Jan. 31, 2011

Related U.S. Application Data
(62) Division of application No. 11/895,167, filed on Aug. 23, 2007, now abandoned.
(60) Provisional application No. 60/840,223, filed on Aug. 25, 2006.

(51) Int. Cl. B28B 1/50

(52) U.S. Cl. 264/44

(57) ABSTRACT

Disclosed are porous ceramic honeycomb articles, such as filters, which are composed predominately of a cordierite composition. The ceramic honeycomb articles possess a porous microstructure characterized by a unique combination of relatively high porosity (>45%), and moderately narrow pore size distribution wherein greater than 15% and less than 38% of the total porosity exhibits a pore diameter less than 10 μm, and low CTE wherein CTE≦6.0×10⁻⁷/° C. (from 23° C. to 800° C.). The articles exhibit high thermal durability and high filtration efficiency coupled with low pressure drop. Such ceramic articles are particularly well suited for use in filtration applications, such as in diesel exhaust filters. Also disclosed are methods for manufacturing the porous ceramic honeycomb article.

This application claims the benefit of U.S. Provisional Application No. 60/840,223, filed Aug. 25, 2006, entitled “Low Back Pressure Porous Cordierite Ceramic Honeycomb Article and Methods for Manufacturing Same.”

### BACKGROUND OF THE INVENTION

1. Field of the Invention

The present invention relates to ceramic articles, and more particularly to porous cordierite ceramic honeycomb articles having properties suitable for use in exhaust after-treatment applications, particularly exhaust filtration, and methods for manufacturing such ceramic honeycomb articles.

2. Technical Background

Recently, much interest has been directed towards the diesel engine due to its fuel efficiency, durability and economical aspects. However, diesel emissions have been scrutinized both in the United States and Europe for their possibly adverse effects. As such, stricter environmental regulations will likely require diesel engines to be held to stricter emissions standards. Accordingly, diesel engine manufacturers and emission-control companies are working to achieve diesel engines which are faster, cleaner and meet stringent emission requirements under all operating conditions with minimal cost to the consumer.

One of the biggest challenges in lowering diesel emissions is controlling the levels of diesel particulate material present in the diesel exhaust stream. Diesel particulate material consists mainly of carbon soot. One way of removing the carbon soot from the diesel exhaust is through the use of diesel particulate filters (otherwise referred to as “wall-flow filters” or “diesel soot traps”). Diesel particulate filters capture the soot in the diesel exhaust on, or in, porous walls of the filter body. The diesel particulate filter is designed to provide for nearly complete filtration of soot without significantly hindering the exhaust flow. However, as the layer of soot collects in the inlet channels of the diesel particulate filter, the lower permeability of the soot layer causes a gradual rise in the back pressure of the filter against the engine, causing the engine to work harder. Thus, once the soot in the filter has accumulated to some level, the filter must be regenerated by burning out the soot, thereby restoring the back pressure again to relatively low levels. Normally, this regeneration is accomplished under controlled conditions of engine management whereby a slow burn is initiated which lasts for a number of minutes, during which the temperature in the filter rises from a lower operational temperature to a higher temperature.

Cordierite, being a low-cost material, in combination with offering a relatively low coefficient of thermal expansion (CTE), is a desirable material choice for diesel exhaust filtration. To that end, porous cordierite ceramic filters of the wall-flow type have been utilized for the removal of particles in the exhaust stream from some diesel engines. Although sufficient for some applications, such prior art filters may have higher back pressures than desired.

Diesel particulate filter design requires the balancing of several properties, including porosity, pore size distribution, thermal expansion, strength, elastic modulus, pressure drop, and manufacturability. Further, several engineering tradeoffs may be required in order to fabricate a filter having an acceptable combination of physical properties and processability. For example, increased porosity may be attainable through manipulation of raw materials, use of pore forming agents, and/or controlling sintering temperatures. However, each of these may result in an increase in thermal expansion coefficients which may compromise the ability of the filter to withstand repeated thermal cycles in use.

Accordingly, it would be considered an advancement to obtain an optimized ceramic honeycomb article, made of cordierite, which is suitable for use in filter applications, especially light duty diesel filter applications, and which exhibits high thermal durability and high filtration efficiency coupled with low pressure drop across the filter and methods of manufacturing therefor.

### SUMMARY OF THE INVENTION

The present invention relates to porous cordierite ceramic honeycomb articles, and more particularly to porous cordierite-containing ceramic honeycomb articles, such as particulate filters, having properties suitable for use in exhaust after-treatment applications; particularly diesel exhaust filtration.

According to embodiments of the present invention, a porous ceramic honeycomb article is provided containing a predominant phase of cordierite and having a relatively high total porosity (% P), as measured by mercury porosimetry, of greater than 45%, a relatively low Coefficient of Thermal Expansion (CTE) wherein CTE≦6.0×10⁻⁷/° C. (from 23° C. to 800° C.), and which also exhibits a moderately narrow pore size distribution wherein greater than 15% and less than 38% of the total porosity has a pore diameter less than 10 μm. The porous ceramic honeycomb article of the invention advantageously exhibits a combination of excellent filtration efficiency, low back pressure and low CTE.

Additionally, to further improve filtration efficiency, the large porosity portion making up the total porosity may be limited by providing a pore microstructure of the distribution wherein less than 10% of the total porosity has a pore diameter greater than 30 μm, or even where less than 10% of the total porosity has a pore diameter greater than 25 μm. Exemplary embodiments of the invention may exhibit % P>48%; % P<54%; or even 48%<% P<54%.

According to certain exemplary embodiments of the invention, having a relatively larger amount of small pores, greater than or equal to 20% of the total porosity has a pore diameter less than 10 μm, or even greater than or equal to 25% of the total porosity has a pore diameter less than 10 μm. The ceramic honeycomb article may further comprise less than or equal to 35% of the total porosity having a pore diameter less than 10 μm; less than or equal to 30% of the total porosity having a pore diameter less than 10 μm, or even less than or equal to 25%, thereby limiting the maximum volume of small pores. In some embodiments, greater than or equal to 20% and less than or equal to 30% of the total porosity exhibit a pore diameter less than 10 μm. Thus, the porous cordierite ceramic honeycomb article of the invention advantageously includes a moderate amount of small pores thereby providing improved filtration efficiency and relatively low coated pressure drop. In yet further embodiments of the invention having a relatively low percentage of small pores, greater than 15% and less than or equal to 25% of the total porosity has a pore diameter less than 10 μm, or even greater than 15% and less than or equal to 22%. In yet further embodiments, greater than or equal to 17% and less than or equal to 22% of the total porosity have a pore diameter less than 10 μm. In other embodiments, greater than or equal to 17% and less than or equal to 25% of the total porosity have a pore diameter less than 10 μm. Limiting the volume amount of small pores to be relatively moderate results in improved coated pressure drop for the inventive porous cordierite ceramic filter article combined with excellent filtration efficiency.

Additionally, according to further embodiments of the invention, the cordierite ceramic honeycomb article may exhibit an even lower CTE wherein CTE≦5.0×10⁻⁷/° C. across the temperature range of from 23° C. to 800° C. In some exemplary embodiments CTE≦4.5×10⁻⁷/° C. (23° C. to 800° C.), or even CTE≦4.0×10⁻⁷/° C. (23° C. to 800° C.).

Furthermore, the ceramic honeycomb article may exhibit a moderately narrow pore size distribution of the small portion of the pore size distribution. Such moderately narrow pore size distribution may be alternatively or additionally characterized by d_{f}≦0.65, wherein d_{f}=(d₅₀−d₁₀)/d₅₀; or even d_{f}≦0.55. Yet further exemplary embodiments may be characterized by 0.40≦d_{f}≦0.60, or even 0.45≦d_{f}≦0.55. d₁₀, d₉₀ and d₅₀ are as defined herein below.

According to additional embodiments, the overall narrowness of the pore distribution of the porous cordierite honeycomb article may be further characterized as exhibiting a distribution breadth with d_{b}≦2.3, wherein d_{b}=(d₉₀−d₁₀)/d₅₀, or even d_{b}≦1.9. In some embodiments, d_{b}≦1.8. Moreover, according to exemplary embodiments of the invention, the porous ceramic honeycomb filter may exhibit a mean pore diameter (d₅₀) wherein 10 μm≦d₅₀≦17.5 μm, or even 10 μm≦d₅₀≦15 μm. In certain embodiments, the mean pore diameter (d₅₀) is 15 μm≦d₅₀≦17.5 μm.

Other exemplary embodiments of the invention exhibit combinations of properties exceedingly useful for particle filtration in diesel exhaust systems, i.e., for diesel particulate filters. Such embodiments are directed to cordierite ceramic honeycomb articles including combinations of 48%<% P<54%, 10 μm≦d₅₀≦17.5 μm, CTE≦5.0×10⁻⁷/° C. (from 23° C. to 800° C.), and 0.40≦d_{f}≦0.60, wherein d_{f}=(d₅₀−d₁₀)/d₅₀. Such combinations exhibit excellent thermal shock resistance, as well as low pressure drop, and good filtration efficiency in the porous ceramic filter article.

Further, the inventive ceramic honeycomb article of the invention is suitable for use in high temperature applications, it that it exhibits excellent strength wherein MOR is greater than or equal to 250 psi; or even greater than or equal to 350 psi; or even greater than or equal to 450 psi.

The inventive ceramic honeycomb article of the invention is suitable for use in high temperature applications, and are particularly suitable for use as diesel exhaust filtration devices because they exhibit low pressure drop, high filtration efficiency, and good thermal durability. To this end, in another aspect, the ceramic honeycomb article may exhibit the structure of a honeycomb particulate filter. In particular, the filter may have an inlet end and an outlet end, a multiplicity of cell channels extending from the inlet end to the outlet end, the cell channels being formed from interconnecting porous walls, wherein part of the total number of cell channels are plugged along a portion of their lengths. In one embodiment, certain of the cells may be plugged at the inlet end and the remaining part of the cells that are open at the inlet end may be plugged at the outlet end along a portion of their lengths. In so doing, the engine exhaust stream passing through the cells of the honeycomb from the inlet end to the outlet end flows into the open cells, then through the cells walls, and out of the article through the open cells at the outlet end.

In another broad aspect of the present invention, a method for manufacturing a porous ceramic honeycomb article, as described above, is provided. The manufacturing method comprises the steps of providing a plasticized cordierite precursor batch composition containing inorganic batch components; a graphite pore former having a median particle diameter less than 50 μm; a liquid vehicle; and a binder. The inorganic batch components are selected from the group of a magnesium oxide-forming source, an alumina-forming source, and a silica-forming source. A honeycomb green body is formed from the plasticized ceramic precursor batch composition and subsequently fired under conditions effective to convert the green body into a ceramic honeycomb article containing cordierite. According to embodiments of the invention, the resulting fired cordierite ceramic honeycomb article has a total porosity >45%, CTE≦6.0×10⁻⁷/° C. (from 23° C. to 800° C.), and exhibits a moderately narrow pore size distribution wherein greater than 15% and less than 38% of the total porosity has a pore diameter less than 10 μm.

In accordance with yet further embodiments of the invention, a method of manufacturing a ceramic honeycomb article is provided, comprising the steps of providing a honeycomb green body having a batch composition containing inorganic batch components selected from a magnesium oxide-forming source, an alumina-forming source, and a silica-forming source, and a pore former; and firing the honeycomb green body under firing conditions effective to convert the honeycomb green body into a porous ceramic honeycomb article having a porosity greater than 45% wherein said firing conditions include an upper temperature region between 1100° C. and 1400° C. and an average ramp rate across the upper temperature region is greater than 20° C./hr; or greater than 25° C./hr; or even greater than 30° C./hr.

Additional aspects and features of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention.

FIG. 1 is a graph of exemplary embodiments of the invention illustrating the moderate narrowness of the pore size distribution and showing pore size range vs. % of porosity in the range according to embodiments of the present invention.

FIG. 2 is a perspective view of a porous cordierite ceramic honeycomb filter article according to embodiments of the present invention.

FIG. 3 is a graph illustrating an exemplary firing schedule for the porous ceramic honeycomb article according to further embodiments of the present invention.

FIG. 4 is a graph of the pore size distribution of further exemplary embodiments of the invention illustrating the moderate narrowness of the pore size distribution.

FIGS. 5 and 6 are magnified micrographs of exemplary embodiments of the invention illustrating the interconnectedness of the pore distribution.

### DETAILED DESCRIPTION

The present invention can be understood more readily by reference to the following detailed description, examples, and claims, and their previous and following description. However, before the present articles and/or methods are disclosed and described, it is to be understood that this invention is not limited to the specific ceramic honeycomb articles and/or manufacturing methods disclosed unless otherwise specified. It is also to be understood that the terminology used herein is for the purpose of describing particular aspects only, and is not intended to be limiting.

The following description of the invention is provided as an enabling teaching of the invention in its best, currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As briefly introduced above, the present invention, in one aspect thereof, provides an improved porous cordierite ceramic honeycomb filter article useful for exhaust filter applications which exhibits relatively high porosity, relatively high thermal durability, coupled with relatively low pressure drop and preferably also includes relatively high filtration efficiency. To this end, a pore microstructure is provided in the fired porous cordierite ceramic honeycomb body that is characterized by a relatively high level of porosity (>45%), a relatively low CTE (less than or equal to 6.0×10⁻⁷/° C. (from 23° C. to 800° C.), and a moderately narrow pore size distribution wherein the pore size distribution exhibits greater than 15% and less than 38% of the total porosity having a pore diameter less than 10 μm. It has been found that such a cordierite microstructure enables wash coat loadings, such as alumina wash coats, to be applied to the walls of the honeycomb filter article with a relatively minimal resulting increase in backpressure (i.e., resulting in low wash-coated back pressure). Moreover, such structures provide improved thermal shock durability by virtue of their relatively low CTE. Additionally, the structure exhibits excellent filtration efficiency by virtue of the moderate narrow pore size distribution and controlled porosity.

In accordance therewith, the present invention provides a porous cordierite ceramic honeycomb filter, which, in one aspect, is composed predominately of a crystalline phase cordierite composition. In particular, the walls of the filter are preferably formed by the reaction of raw inorganic materials and contain a phase approximating the stoichiometry of Mg₂Al₄Si₅O₁₈. Preferably, the porous ceramic filter article is made up of predominantly cordierite; with preferably greater than 90%, or even 93%, of the phase assemblage containing cordierite. The porous walls of the cordierite ceramic honeycomb filter are characterized by a unique combination of relatively high porosity (but not too high), moderately narrow pore microstructure (but not too narrow), and relatively low CTE. In particular, the total porosity of the walls is greater than 45%, or even greater than 48%. Preferably also, the total porosity may also be less than 54%; and in some embodiments the total porosity may be greater than 48% and less than 54%, for example.

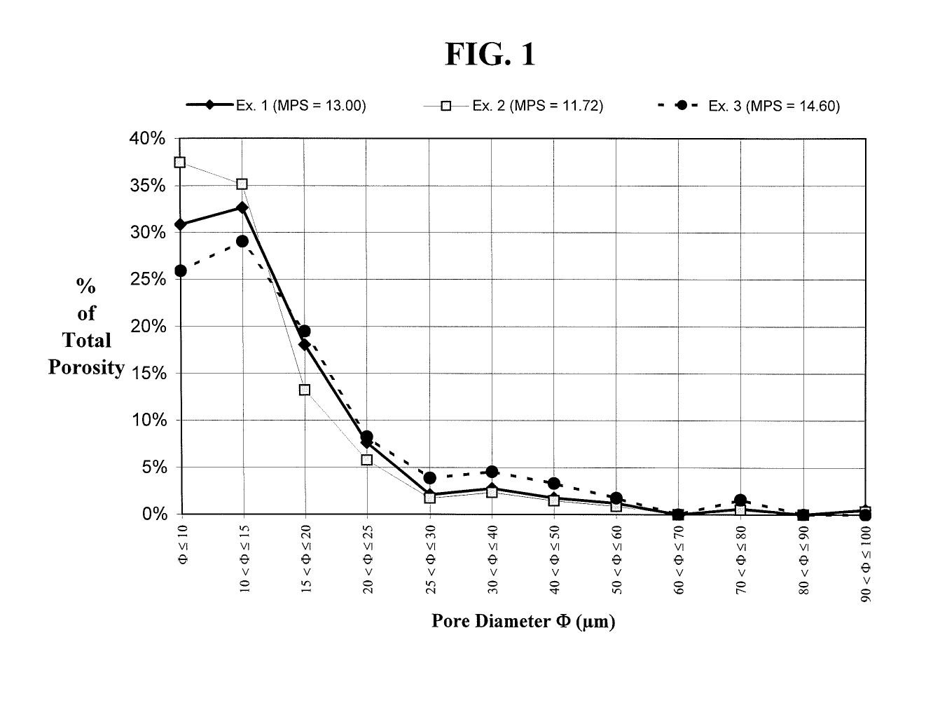

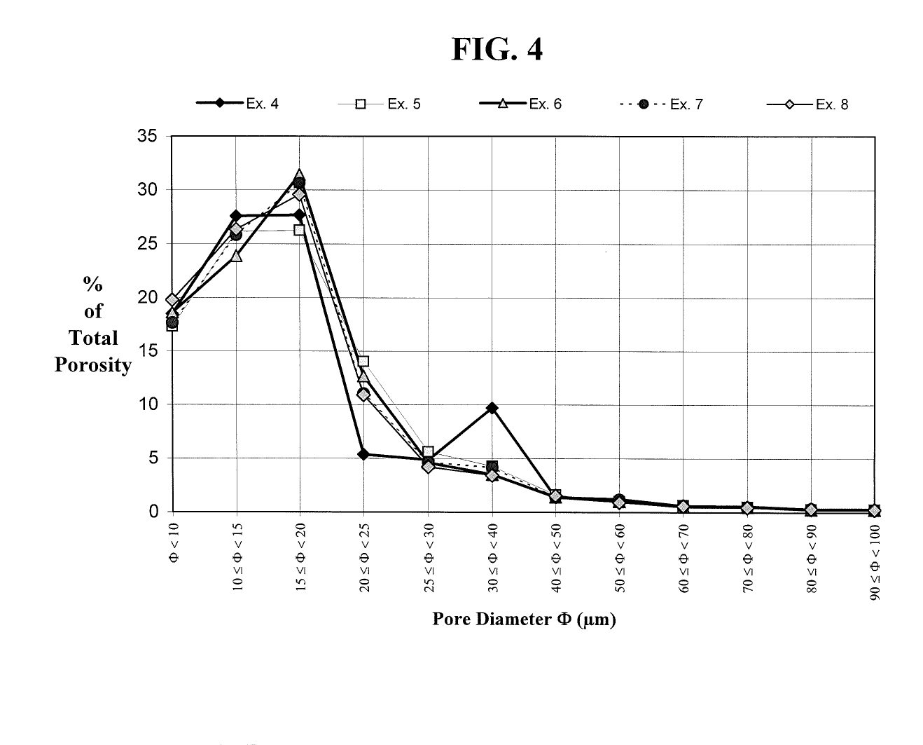

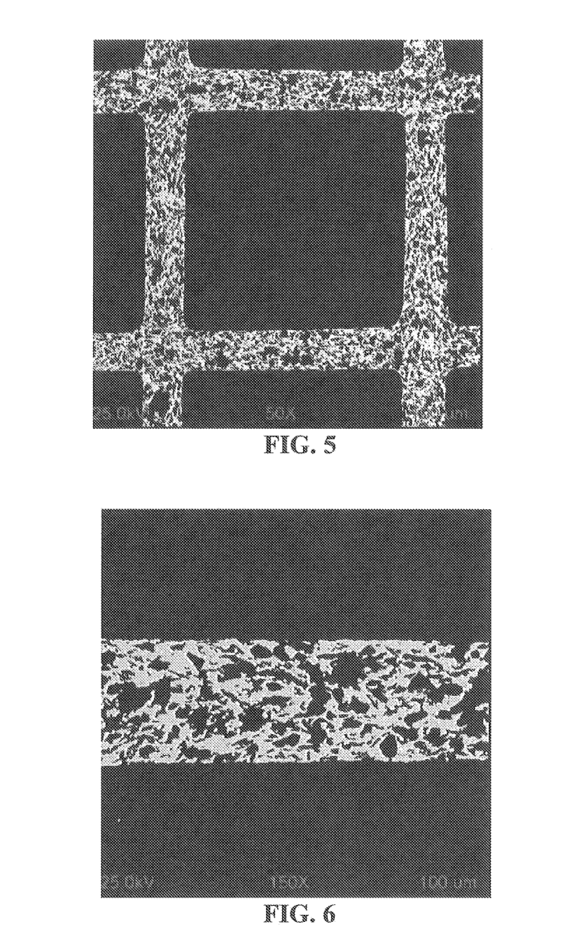

The pore microstructure of the walls of the honeycomb article are characterized by interconnected porosity (See FIGS. 5 and 6) and moderately narrow pore size distribution (See FIGS. 1 and 4), wherein greater than 15% and less than 38% of the total porosity has a pore diameter of less than 10 μm. According to the embodiments illustrated in FIG. 1, the pore microstructure may be characterized by a pore size distribution wherein greater than or equal to 20% of the total porosity has a diameter less than 10 μm, or even greater than or equal to 25% of the total porosity has a diameter less than 10 μm. In certain of the embodiments, less than or equal to 35% of the total porosity has a pore diameter less than 10 μm; or even less than or equal to 30% of the total porosity has a pore diameter less than 10 μm. According to other embodiments, the pore microstructure is characterized by a moderately narrow pore size distribution, wherein greater than or equal to 20% and less than or equal to 30% of the total porosity has a pore diameter of less than 10 μm.

In the embodiments best illustrated in FIG. 4, greater than 15% and less than or equal to 25%, or even greater than 15% and less than or equal to 22%, or even greater than 15% and less than or equal to 20%, of the total porosity has a pore diameter of less than 10 μm. In certain exemplary embodiments, less than or equal to 25% and greater than or equal to 17%, or even less than or equal to 22% and greater than or equal to 17% of the total porosity have a pore size less than 10 μm. Having a moderate percentage of small pores less than 10 μm is desirable to minimize the propensity of such pores to be come blocked by wash coating during the alumina wash coating process. Accordingly, the wash-coated pressure drop across the filter article is significantly reduced, by as much as 15% or more, as compared to porous cordierite filter articles having comparable total porosity but with greater than 40% of the total porosity having a pore diameter of less than 10 μm according to the prior art. Moreover, the moderately narrow percentage of small pores of the present invention may increase the filtration efficiency as compared to porous-walled honeycomb structures having a very small amount of small pores (less than 15% of the porosity having a pore diameter of less than 10 μm). Thus, back pressure reductions are achievable, while not sacrificing filtration efficiency.

Additionally, the large porosity portion making up the total porosity may be controlled according to embodiments of the invention by providing a pore microstructure of the distribution wherein less than 10% of the total porosity has a pore diameter greater than 30 μm; or even where less than 10% of the total porosity has a pore diameter greater than 25 μm. Controlling the large pore content further improves filtration efficiency. Moreover, it also improves strength thereby proving MOR of greater than or equal to 250 psi; or even greater than or equal to 350 psi; or even greater than or equal to 450 psi.

The moderately narrow pore size distribution is achieved in the inventive cordierite ceramic honeycomb article according to the invention while also retaining good thermal shock resistance by virtue of retaining an axial coefficient of thermal expansion (CTE) between temperatures of 23° C. and 800° C. of CTE≦6.0×10⁻⁷/° C. Thus, another advantage of the inventive filters is a low thermal expansion resulting in excellent thermal shock resistance (TSR). TSR is inversely proportional to the coefficient of thermal expansion (CTE). That is, honeycomb ceramic filters with low thermal expansion have good thermal shock resistance and can survive the wide temperature fluctuations that are encountered during regeneration in end use filter applications. The coefficient of thermal expansion (CTE), as used herein, is measured by dilatometry, in the axial direction. In several outstanding exemplary embodiments of the invention, CTE≦5.0×10⁻⁷/° C. across the temperature range of from 23° C. to 800° C.; or even CTE≦4.5×10⁻⁷/° C. (see Tables 4 and 5 below); or even CTE≦4.0×10⁻⁷/° C. (see Tables 4 and 5 below).

Exemplary embodiments of the invention achieve a total porosity greater than 45%, CTE≦6.0×10⁻⁷/° C. (23° C. to 800° C.), and a moderately narrow pore size distribution wherein greater than 15% and less than 38% of the total porosity has a pore diameter less than 10 μm, while additionally exhibiting high strength with modulus of rupture (MOR) of greater than or equal to 250 psi, greater than or equal to 350 psi, or even greater than or equal to 450 psi. MOR is measured on a 200/12 cell geometry measured on a rectangular cellular bar having 4×1×½ inch dimensions and in the axial direction by the four-point method. In addition, the invention may achieve an elastic modulus, eMod, at 23° C. of less than 9×10⁶ psi, or even less than 8×10⁶ psi, as measured according to ASTM C 623.

The parameters d₁₀, d₅₀ and d₉₀ relate to various diameters of the pore size distribution and will be used herein, among other parameters, to further define the extent of the moderately narrow pore size distribution. The quantity d₅₀ is the median pore diameter based upon pore volume, and is measured in μm; thus, d₅₀ is the pore diameter at which 50% of the open porosity of the ceramic honeycomb article has been intruded by mercury. The quantity d₉₀ is the pore diameter at which 90% of the pore volume is comprised of pores whose diameters are smaller than the value of d₉₀; thus, d₉₀ is equal to the pore diameter at which 10% by volume of the open porosity of the ceramic has been intruded by mercury. The quantity d₁₀ is the pore diameter at which 10% of the pore volume is comprised of pores whose diameters are smaller than the value of d₁₀; thus, d₁₀ is equal to the pore diameter at which 90% by volume of the open porosity of the ceramic has been intruded by mercury. The values of d₁₀ and d₉₀ are also in units of microns.

To further illustrate the moderate narrowness of the pore size distribution of the structure of the inventive honeycomb article, the porosity is controlled such that d₁₀ is preferably greater than or equal to 4.5 μm. In still other embodiments, d₁₀ may be greater than or equal to 5.0 μm, or even greater than or equal to 6.0 μm or even 7.0 μm. In certain exemplary embodiments, d₁₀ may be less than or equal to 10.0 μm, or even less than 8.0 μm.

Additionally, the moderately narrow pore size distribution is achieved by also controlling the large pore portion of the pore distribution. In particular, d₉₀ of the wall porosity is preferably controlled to be less than or equal to 50.0 μm. In still another aspect, d₉₀ may be less than or equal to 40.0 μm, or even less than or equal to 32.0 μm. In several embodiments, d₁₀ is greater than 4.0 μm and d₉₀ is less than or equal to 32.0 μm. In yet further embodiments, d₉₀ is less than or equal to 30.0 μm. In exemplary embodiments, d₁₀ is greater than or equal to 5.0 μm and d₉₀ is less than or equal to 27.0 μm, or even 25 μm.

In an additional aspect, the moderate pore size distribution of the inventive ceramic honeycomb filters are evidenced by the width of the distribution of pore sizes finer than the median pore size, d₅₀. As used herein, the width of the distribution of pore sizes finer than the median pore size, d₅₀, are represented by a so-called “d_{f}” value which expresses the quantity (d₅₀−d₁₀)/d₅₀. To this end, the porous ceramic filter of the present invention, in one aspect thereof, comprises a d_{f} less than or equal to 0.65, less than or equal to 0.60, or even less than or equal to 0.55. In addition, d_{f} greater than or equal to 0.40, or even greater than or equal to 0.45 may be exhibited. Exemplary embodiments exhibit d_{f} less than or equal to 0.60 but greater than or equal to 0.40, or even d_{f} less than or equal to 0.55 but greater than or equal to 0.45.

The moderately narrow pore size distribution of the inventive ceramic filters is also evidenced by the width of the distribution of pore sizes that are finer and coarser than the median pore size, d₅₀. As used herein, the width of the distribution of pore sizes that are finer and coarser than the median pore size, d₅₀, are represented by a “d_{b}” value which expresses the quantity (d₉₀−d₁₀)/d₅₀. To this end, the ceramic pore structure of the present invention filter in one aspect comprises a pore size distribution with a d_{b}≦2.3. In certain exemplary embodiments, d_{b}≦1.9, or even d_{b}≦1.8. Extremely narrow pore size distribution embodiments in accordance with aspects of the invention exhibit d_{b}≦1.5, or even d_{b}≦1.4, or even d_{b}≦1.3.

The median pore diameter, d₅₀, of the pores present in the instant ceramic articles is, in one aspect, greater than or equal to 10 μm. In another aspect, the median pore diameter, d₅₀, is in the range of from greater than or equal to 10 μm to less than or equal to 17.5 μm. In another aspect, the median pore diameter, d₅₀, can be in the range of from greater than or equal to 10 μm to less than or equal to 15 μm. In yet another aspect, the median pore diameter, d₅₀, can be in the range of from greater than or equal to 15 μm to less than or equal to 17.5 μm. These ranges provide suitable filtration efficiencies.

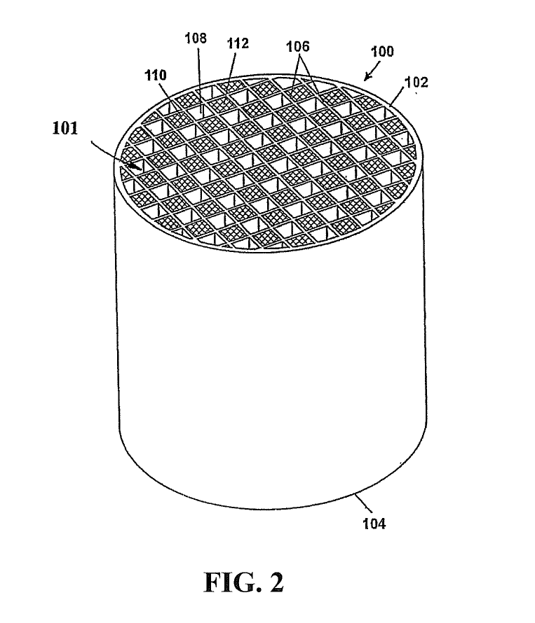

The ceramic honeycomb articles of the present invention can have any frontal shape or geometry suitable for a particular application such as round, ellipse, oval, triangular, or square, prism, for example. The sides may be cylindrical or bent in a “doglegged shape,” or the like. In addition, the shape of through holes is not particularly limited. For example, the cell channels may have any cross-sectional shape, such polygonal, square, rectangular, hexagonal, octagonal, circular, elliptical, triangular, diamond, or other shapes, or combinations thereof. In high temperature filtration applications, such as diesel particulate filtration, for which the inventive articles are especially suited, it is preferred the ceramic honeycomb articles have a multicellular monolithic structure, which is preferably plugged, such as to form an end-plugged ceramic honeycomb monolith as shown in FIG. 2.

The honeycomb article 100 preferably has an inlet end 102 and outlet end 104, and a multiplicity of cell channels 108, 110 extending from the inlet end to the outlet end, the cells formed from intersecting porous walls 106. The inventive articles 100 of the invention may have a cellular density from about 70 cells/in² (10.9 cells/cm²) to about 400 cells/in² (62 cells/cm²), for example. When the article is a wall-flow filter, preferably a portion of the cells 110 are plugged with a paste having same or similar composition to that of the cellular body 101, as described in U.S. Pat. No. 4,329,162, for example. The plugging may be performed at one or more of the ends of the cells and form plugs 112 typically having a depth of about 5 to 20 mm, although this can vary. Plugging preferably occurs in a pattern. In one implementation, a portion of the cells on the outlet end 104 but not corresponding to those on the inlet end 102 may be plugged in a similar alternating pattern, such as a checkerboard pattern. Therefore, in this implementation, each cell is preferably plugged only at one end. One arrangement is to have every other cell on a given face plugged as in a checkered pattern as shown in FIG. 2, although other plugging configurations may be optionally employed, such as where only selected channels of only one end are plugged.

In operation, an exhaust stream containing particulates flows into the filter 100 through the open cells at the inlet end 102, then through the porous cell walls 106, and out through the open cells at the outlet end 104. Filters 100 of the type herein described are known as “wall-flow” filters since the flow paths resulting from alternate channel plugging require the exhaust being treated to flow through the porous ceramic cell walls prior to exiting the filter.

According to additional embodiments of the invention, also provided is a method for manufacturing the inventive porous cordierite articles described above. To this end, it has now been discovered that a ceramic article having the aforementioned microstructure can be achieved from a ceramic precursor batch composition which comprises a fine pore former, particularly a graphite pore former. Accordingly, the method of the present invention generally comprises the steps of first providing a plasticized ceramic precursor batch composition comprising inorganic ceramic forming batch component(s), a fine pore former (preferably graphite having a median particle size of less than 50 μm, as measured on a sedigraph), a liquid vehicle, and a binder; then forming a green honeycomb body having a desired shape from the plasticized ceramic precursor batch composition; preferably drying and then firing the formed green body under conditions effective to convert the green body into a ceramic article containing cordierite.

The inorganic batch components can be any combination of inorganic components which can, upon firing, provide a porous ceramic having primary sintered phase composition comprised of cordierite.

In one aspect, the inorganic batch components can be selected from a magnesium oxide-forming source; an alumina-forming source; and a silica-forming source. The batch components are further selected so as to yield a ceramic article comprising predominantly cordierite, or a mixture of cordierite, mullite and/or spinel upon firing, for example. For example, and without limitation, in one aspect, the inorganic batch components can be selected to provide a ceramic article which comprises at least about 90% by weight cordierite; or more preferably 93% by weight cordierite. The cordierite-containing ceramic honeycomb article consists essentially of, as characterized in an oxide weight percent basis, from about 49 to about 53 percent by weight SiO₂, from about 33 to about 38 percent by weight Al₂O₃, and from about 12 to about 16 percent by weight MgO.

To this end, an exemplary inorganic cordierite precursor powder batch composition preferably comprises about 33 to about 41 weight percent of an alumina-forming source, about 46 to about 53 weight percent of a silica-forming source, and about 11 to about 17 weight percent of a magnesium oxide-forming source. Exemplary non-limiting inorganic batch component mixtures suitable for forming cordierite are those disclosed in U.S. Pat. No. 3,885,977, for example.

The inorganic ceramic batch components can be synthetically produced materials such as oxides, hydroxides, and the like. Alternatively, they can be naturally occurring minerals such as clays, talcs, or any combination thereof. Thus, it should be understood that the present invention is not limited to any particular types of powders or raw materials.

In one aspect, an exemplary and non-limiting magnesium oxide-forming source may comprise talc. In a further aspect, suitable talcs can comprise talc having a median particle size of at least about 10 μm, or even at least about 15 μm. Particle size is measured by a particle size distribution (PSD) technique, preferably by a Micrometrics 5100 series Sedigraph. Talc having particle sizes of between 15 μm and 20 μm are preferred. In still a further aspect, the talc may be a platy talc. As used herein, a platy talc refers to talc that exhibits a platelet particle morphology, i.e., particles having two long dimensions and one short dimension, or, for example, a length and width of the platelet that is much larger than its thickness. In one aspect, the talc possess a morphology index greater than about 0.50, 0.60, 0.70, or even 80. To this end, the morphology index, as disclosed in U.S. Pat. No. 5,141,686, is a measure of the degree of platiness of the talc. One typical procedure for measuring the morphology index is to place the sample in a holder so that the orientation of the platy talc is maximized within the plane of the sample holder. The x-ray diffraction (XRD) pattern can then be determined for the oriented talc. The morphology index semi-quantitatively relates the platy character of the talc to its XRD peak intensities using the following equation:

$$M = \frac{{I}_{x}}{{I}_{x} + 2 {I}_{y}}$$

where Iₓ is the intensity of the peak and I_{y} is that of the reflection.

Suitable silica-forming sources can in one aspect comprise clay or mixtures, such as for example, raw kaolin, calcined kaolin, and/or mixtures thereof. Exemplary and non-limiting clays include non-delaminated kaolinite raw clay, having a particle size of about 7-9 micrometers, and a surface area of about 5-7 m²/g, clays having a particle size of about 2-5 micrometers, and a surface area of about 10-14 m²/g, delaminated kaolinite having a particle size of about 0.5-3 micrometers, and a surface area of about 13-17 m²/g, calcined clay, having a particle size of about 1-3 micrometers, and a surface area of about 6-8 m²/g.

In a further aspect, it should also be understood that the silica-forming source may further comprise, if desired, a silica raw material including fused SiO₂; colloidal silica; crystalline silica, such as quartz or cristobalite, or a low-alumina substantially alkali-free zeolite. Further, in still another aspect, the silica-forming source may comprise a compound that forms free silica when heated, such as for example, silicic acid or a silicon organo-metallic compound. The mean particle size of the silica source is preferably greater than 15 μm, as measured by Micrometrics 5100 series Sedigraph. The silica-forming source may include a combination of a silica raw material and clay, for example, a combination of quartz and kaolin clay.

Exemplary alumina-forming sources may include aluminum oxides or a compound containing aluminum which when heated to sufficiently high temperature yields essentially 100% aluminum oxide. Non-limiting examples of alumina-forming sources include corundum or alpha-alumina, gamma-alumina, transitional aluminas, aluminum hydroxide such as gibbsite and bayerite, boehmite, diaspore, aluminum isopropoxide, and the like. Commercially available alumina-forming sources may include aluminas, having a particle size of between about 2-6 μm.

If desired, the alumina-forming source may also comprise a dispersible alumina-forming source. As used herein, a dispersible alumina-forming source is an alumina-forming source that is at least substantially dispersible in a solvent or liquid medium and that can be used to provide a colloidal suspension in a solvent or liquid medium. In one aspect, a dispersible alumina source can be a relatively high surface area alumina source having a specific surface area of at least 20 m²/g. Alternatively, a dispersible alumina source can have a specific surface area of at least 50 m²/g. In an exemplary aspect, a suitable dispersible alumina source for use in the methods of the instant invention comprises alpha aluminum oxide hydroxide (AlOOH.x.H₂O) commonly referred to as boehmite, pseudoboehmite, and as aluminum monohydrate. In another exemplary aspect, the dispersible alumina source can comprise the so-called transition or activated aluminas (i.e., aluminum oxyhydroxide and chi, eta, rho, iota, kappa, gamma, delta, and theta alumina) which can contain various amounts of chemically bound water or hydroxyl functionalities.

As set forth above, the plasticized ceramic precursor batch composition further comprises a fine pore former, preferably graphite. As will be appreciated by one of ordinary skill in the art, a pore former is an organic fugitive particulate material which evaporates or undergoes vaporization by combustion during drying or heating of the green body to obtain a desired, usually larger porosity and/or coarser median pore diameter than would otherwise be obtained. It has been discovered that the use of certain fine particle size graphite pore formers, preferably graphite having a median particle size of less than 50 μm, less than 25 μm, or even less than 20 μm, or even between 10 μm and 45 μm, enables the manufacture of porous cordierite ceramic honeycomb articles possessing the unique combination of microstructure and physical properties described above. Further, the graphite pore former can be present in any amount effective to provide the desired total porosity >45%. However, in one aspect, the graphite is present in an amount in the range of about 10% to −30 wt. % relative to the total weight of the inorganic batch components, more preferably between about 15% to −25 wt. %.

The inorganic batch components and the pore former can be intimately blended with a liquid vehicle and forming aids which impart plastic formability and green strength to the raw materials when they are shaped into a green body. Forming of the green body may be done by any suitable forming method, for example, molding or extrusion. When forming is done by extrusion, most typically a cellulose ether binder such as methylcellulose, hydroxypropyl methylcellulose, methylcellulose derivatives, and/or any combinations thereof, serve as a binder, and sodium stearate or oleic acid serves as a lubricant. The relative amounts of forming aids can vary depending on factors such as the nature and amounts of raw materials used, etc. For example, the typical amounts of forming aids are about 2% to about 10% by weight of methyl cellulose, and preferably about 3% to about 6% by weight, and about 0.5% to about 2% by weight sodium stearate or oleic acid, and preferably about 1.0% by weight. The raw inorganic materials, binder and pore formers are typically mixed together in dry form, and then mixed with the forming aids and water as the vehicle. The amount of water can vary from one batch of materials to another and therefore is determined by pre-testing the particular batch for extrudability.

The liquid vehicle component can vary depending on the type of material used in order to in part optimum handling properties and compatibility with the other components in the ceramic batch mixture. Typically, the liquid vehicle content is usually in the range of from 20% to 50% by weight of the plasticized composition. In one aspect, the liquid vehicle component may comprise water.

The resulting stiff, uniform, and extrudable plasticized cordierite ceramic-forming precursor batch composition can then be shaped into a green body by any known conventional ceramic forming process, such as, e.g., extrusion, injection molding, slip casting, centrifugal casting, pressure casting, dry pressing, and the like. In an exemplary aspect, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die.

The instant method and the resulting ceramic articles are in one aspect especially suited for use as diesel particulate filters. Specifically, the inventive ceramic articles are especially suited as multi-cellular honeycomb articles having a relatively high porosity, a low pressure drop between the entrance and exit faces of the filter, a low CTE, and high filtration efficiency. To this end, in one aspect the plasticized ceramic precursor batch composition can be formed or otherwise shaped into a honeycomb configuration. Although a honeycomb ceramic article of the present invention normally has a structure in which a plurality of through holes opened to the end surface of the exhaust gas flow-in side and to the end surface of the exhaust gas flow-out side are alternately sealed at both the end surfaces, the shape of the honeycomb filter is not particularly restricted.

The formed green body having a desired size, configuration and cell shape, as described above, can then be dried to remove excess moisture therefrom. The drying step can be performed by hot air, microwave, steam, or dielectric drying, or combinations and may be followed by ambient air drying. Once dried, the green body can thereafter be fired (sintered) under firing conditions effective to convert the green body into a ceramic article comprising a primary crystalline phase ceramic composition, for example, as described below.

The firing conditions effective to convert the green body into a ceramic honeycomb article can vary depending on, for example, the specific composition, size of the green body, and nature of the equipment used. To that end, in one aspect, the optimal firing conditions specified herein may need to be adapted for very large cordierite structures, i.e., slowed down, for example.

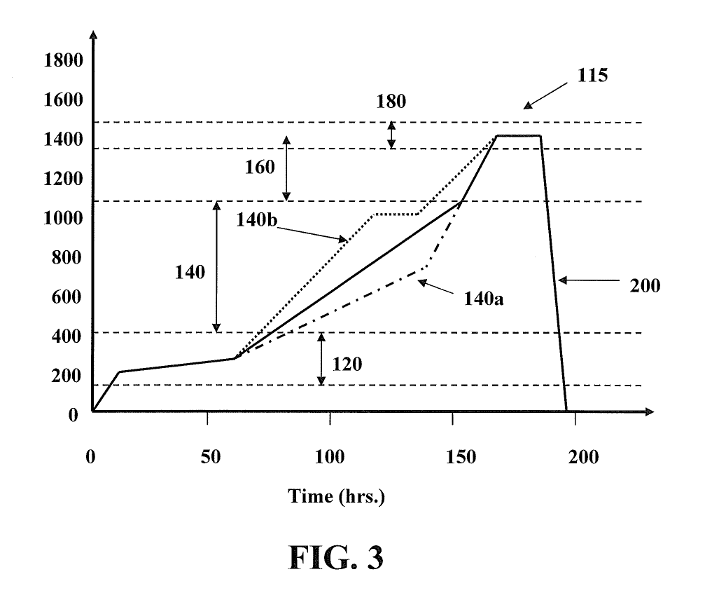

However, in one aspect, for the plasticized batch mixtures described herein that are primarily used for forming cordierite ceramic articles of nominal size, for example articles of having an outside volume envelope of between about 50-250 in², the firing conditions may be as shown in the firing schedule 115 of FIG. 3. In particular, the porous cordierite ceramic article is manufactured by firing according to a the firing schedule 115 with the steps of heating the formed honeycomb green body in a standard kiln or furnace to a maximum soak temperature in a top temperature region 180 of between about 1350° C. to about 1450° C. In still another aspect, the honeycomb green body may be fired at a maximum soak temperature in the region 180 from about 1400° C. to about 1435° C.

The total elapsed firing time can range from approximately 100 to 300 hours or more, during which a maximum soak temperature in the top temperature region 180 can be reached and held for an effective soak time in the range of from about 5 hours to about 50 hours, or even between about 10 hours to about 40 hours, to convert the body into a ceramic honeycomb article having a predominant cordierite phase. One embodiment of firing schedule includes firing at a top temperature of between about 1415° C. and 1435° C. for between about 10 hours to about 35 hours.

As briefly stated above, and as further exemplified in the appended examples, the use of fine graphite as a pore former in combination with the plasticized ceramic precursor batch composition of the present invention when fired according to the exemplary firing schedules herein described produce the resulting ceramic honeycomb article having a unique combination of microstructure characteristics and performance properties claimed.

Additionally, in one aspect, the use of a graphite pore former and the ceramic precursor batch composition of the present invention as described in Table 1 below may allow the use of a relatively faster average ramp rate within an upper temperature region 160 at higher temperatures within the firing cycle 115. By utilizing the faster average ramp rate (defined as the difference in temperature, Δt, across the region divided by the time in the region) across the upper portion 160 between 1100° C. and 1400° C., a lower CTE may be obtained in the cordierite ceramic article, while still obtaining acceptable microstructure characteristics imparting low backpressure in use of the end article and good filtration efficiency. According to one embodiment, the faster average ramp rate across the upper portion 160 between 1100° C. and 1400° C. is greater than 20° C./hr, greater than 25° C./hr.; or even greater than 30° C./hr.

Additionally, according to embodiments of the invention, the top temperature within top temperature region 180 of a given firing cycle 115 can be achieved by increasing the furnace firing temperature according to a defined time and temperature schedule 115 as shown in FIG. 3. The exemplary firing schedule 115 preferably includes a lower temperature region 120 of between about 180° C. and about 400° C. The green body honeycomb is held in this lower temperature region 120 for a sufficient time to substantially completely burn out the binder (typically methocellulose). In one aspect, the temperature is held in the region 120 between about 180° C. and about 400° C. for at least 20 hours, or even 30 hours or more. Within the lower temperature region 120, the average ramp rate is between about 2° C./hr and 11° C./hr.

The firing schedule 115 may also include an intermediate temperature region 140 between about 400° C. and 1100° C. Within this region 140, the average ramp rate across the region between 400° C. and 1100° C. is preferably less than 25° C./hr, or even less than 15° C./hr, or even between, or even greater than 10° C./hr and less than 15° C./hr. This region 140 may include a generally constant ramp rate, or a step or knee such as illustrated by dotted lines labeled 140a, 140b. In one case, such as labeled 140b, the initial ramp rate in the region 140 is greater than 25° C./hr, followed by a hold within a temperature range from 800° C. to 1100° C. The hold may comprise a substantially constant temperature or a reduced ramp rate between 800° C. and 1100° C., such as less than 10° C./hr, or even less than 5° C./hr. Optionally, the cycle 115 may include a slower ramp rate followed by a faster ramp rate as illustrated by dotted line 140a.

Following heating in the intermediate region 140, the honeycomb article is further heated as described above, in the region 160, at an average ramp rate which is less than or equal to about 25° C./hr. Following the top temperature hold in the top temperature region 180, the thus formed cordierite ceramic article is then rapidly cooled to room temperature in cooling portion 200 at a rate of less than about 75° C./hr, for example.

### EXAMPLES

To further illustrate the principles of the present invention, the following examples are put forth so as to provide those of ordinary skill in the art with a complete disclosure and description of how the porous cordierite ceramic honeycomb filters and methods claimed herein are manufactured. They are intended to be purely exemplary of the invention and are not intended to limit the scope of what the inventors regard as their invention. A series of inventive cordierite honeycomb articles were prepared using various combinations of starting raw materials, including, powdered talc, kaolin, alumina-forming sources, silica-forming sources, binder, graphite pore former, liquid vehicle, and lubricant and/or surfactant. The specific inventive powder batch compositions used to prepare the inventive cordierite honeycomb articles are set forth in Tables 1 and 2 below.

TABLE 1
Batch Compositions (Wt. %)

| Composition | A |
|---|---|
| Talc | 40.7 |
| Talc Median Particle Size (μm) | 17.0 |
| Silica Source (Quartz) | 12.5 |
| Silica Median Particle Size (μm) | 20.0 |
| Alumina | 14.8 |
| Alumina Median Particle Size (μm) | 3.0 |
| Aluminum Trihydrate | 16.0 |
| Aluminum Trihydrate Median | 2.0 |
| Particle Size (μm) | |
| Kaolin Clay | 16.0 |
| Kaolin Median Particle Size (μm) | 0.70 |
| Graphite | 20.0 |
| Binder (Methocel) | 4.0 |
| Lubricant | 1.0 |

TABLE 2
Batch Compositions (Wt. %)

| Composition | B |
|---|---|
| Talc | 40.7 |
| Talc Median Particle Size (μm) | 17.0 |
| Silica Source (Quartz) | 12.5 |
| Silica Median Particle Size (μm) | 20.0 |
| Alumina | 14.8 |
| Alumina Median Particle Size (μm) | 3.0 |
| Aluminum Trihydrate | 16.0 |
| Aluminum Trihydrate Median | 2.0 |
| Particle Size (μm) | |
| Kaolin Clay | 16.0 |
| Kaolin Median Particle Size (μm) | 0.70 |
| Pore Former (Graphite) | 20.0 |
| Pore Former Median Particle Size (μm) | 15.0 |
| Binder (Methocel) | 4.0 |
| Lubricant | 1.0 |

To manufacture the inventive cordierite ceramic articles, the dry batch compositions listed in Tables 1 and 2 were charged to a Littleford mixer and then followed by the liquid vehicle addition. The pore former, binder and lubricant and/or surfactant are added as superadditions based upon wt. % of 100% of the inorganic materials. The liquid vehicle addition included between 20 and 32 wt. % of the liquid vehicle, such as water, as a superaddition based upon wt. % of 100% of the inorganic materials. After the liquid addition, the composition is mixed for approximately 3 minutes. The resulting mixture is then mulled in a large muller for approximately 5-20 minutes to provide a final plasticized ceramic precursor batch mixture.

The plasticized batch mixture was then formed into a green honeycomb article, preferably by extrusion through an extrusion die, and under conditions suitable to form honeycomb articles. The green body honeycomb articles thus formed were about 5.66 inches (144 mm) in diameter and had cell geometries of about 200 cells/inch (about 31 cells/cm²). The cell walls had a transverse wall thickness of about 0.012 inch (305 μm), thereby producing a 200/12 cell geometry. Such dies and extrusion processes are taught for example in U.S. Pat. No. 6,455,124 and U.S. Pat. No. 5,205,991.

The green honeycomb articles are then preferably dried immediately using a microwave or RF drier to preferably reach greater than approximately 70% drying. A conventional furnace is then used to remove organics, to further dehydrate the raw materials, and to sinter the green bodies sufficiently to form the ceramic honeycomb articles containing cordierite. The specific firing schedule 115 employed to produce the inventive articles are described above with reference to FIG. 3.

Inventive articles including the batch compositions A-E of Tables 1 and 2 were then fired to provide the inventive porous ceramic articles having a predominant phase of cordierite, and having a highly permeable interconnected open pore structure. The cordierite honeycomb articles when fired generally include an approximate stoichiometry of Mg₂Al₄Si₅O₁₈.

The resulting porous cordierite ceramic honeycomb articles were then evaluated to determine their relevant physical properties, such as for example, CTE (from 23° C. to 800° C.), total porosity (%), median pore diameter (d₅₀), pore size distribution, elastic modulus (EMod), and Modulus Of Rupture (MOR). CTE was measured by dilatometry in the axial direction (parallel to the cell channels). All measurements of pore microstructure were made by mercury porosimetry using an Autopore IV 9520 by Micrometrics. Elastic (Young's) modulus (eMod) was measured on a cellular bar in the axial direction using a sonic resonance technique. Modulus of rupture (MOR) was measured on a rectangular cellular bar having 4×1×½ inch dimensions and in the axial direction by the four-point method. The test results are reported in Tables 4 and 5 below.

An examination of the data set forth in Tables 4 and 5 below indicates the ability for an inventive batch composition and firing schedule of the present invention to provide a resulting fired ceramic honeycomb article having the unique combination of total porosity (P %), CTE, and microstructure. For example, suitable relatively higher porosities (>45%), moderately narrow pore size distribution wherein the pore size distribution has greater than 15% and less than 38% of the total porosity having a pore diameter less than 10 μm, and low CTE (CTE≦6×10⁻⁷/° C.) may be simultaneously achieved according to the invention.

A study of the inventive compositions comprising graphite was conducted to illustrate the effects of differing amounts of graphite pore former and alternative firing schedules would have on the resulting fired ceramic filters. To this end, green bodies comprised of various inventive batch compositions were each fired under firing conditions set forth in Table 3 below. Specifically, the firing schedules reflect alternative combinations of maximum soak temperature, soak time, and average ramp rate. The variations in the resulting properties of axial CTE, total porosity (% P), d₅₀, d₁₀, d₉₀, d_{f}, d_{b} and the pore size distributions are set forth in Tables 4 and 5 below.

TABLE 3
Firing Time & Temperature Conditions

| Firing Conditions | 1 | 2 |
|---|---|---|
| Top Temp (° C.) | 1420 | 1410 |
| Soak Time (hrs) | 20 | 20 |
| Time in low temp region | 42 | 45 |
| (180-400° C.) (hr) | | |
| Time in intermediate region | 61 | 64 |
| (400-1100° C.) (hr) | | |
| Time in upper region | 18 | 9 |
| (1100-1400° C.) (hr) | | |
| Avg. Rate in low temp region | 5 | 5 |
| (180-400° C.) (° C./hr) | | |
| Avg. Rate in intermediate region | 11 | 11 |
| (400-1100° C.) (° C./hr) | | |
| Avg. Rate in upper region | 17 | 33 |
| (1100-1400° C.) (° C./hr) | | |
| Total Elapsed Time | 160 | 180 |

TABLE 4
Inventive Example Properties

| InventiveExample # | 1 | 2 | 3 |
|---|---|---|---|
| Composition | A | A | A |
| Firing Schedule | 1 | 1 | 1 |
| Axial CTE (10⁻⁷/° C.) | 5.1 | 4.9 | 4.9 |
| (23-800° C.) | | | |
| % P | 51.8 | 50.5 | 51.3 |
| d_{f} = (d_{50 -} d₁₀)/d₅₀ | 0.55 | 0.54 | 0.53 |
| d_{b} = (d₉₀ − d₁₀)/d₅₀ | 1.87 | 1.80 | 2.24 |
| MOR (psi) | 466 | 495 | 482 |
| eMOD (10⁶ psi) @ 23° C. | 7.57 | 8.17 | 8.12 |

Pore Size Distribution (μm)

| | | | |
|---|---|---|---|
| Total Intrusion | 0.428 | 0.416 | 0.411 |
| d₁ (μm) | 1.85 | 1.84 | 2.52 |
| d₂ (μm) | 2.80 | 2.71 | 3.57 |
| d₄ (μm) | 3.82 | 3.61 | 4.66 |
| d₅ (μm) | 4.21 | 3.96 | 5.07 |
| d₁₀ (μm) | 5.81 | 5.45 | 6.73 |
| d₂₅ (μm) | 8.98 | 8.21 | 9.88 |
| d₅₀ (μm) | 13.00 | 11.72 | 14.60 |
| d₇₅ (μm) | 17.81 | 15.74 | 21.88 |
| d₉₀ (μm) | 29.51 | 24.49 | 38.36 |

Pore Size Distribution

| | | | |
|---|---|---|---|
| <10 μm | 30.7% | 37.1% | 25.6% |
| >25 μm | 12.9% | 9.7% | 19.8% |
| >30 μm | 9.8% | 7.3% | 14.8% |

Thus, in Table 4, the embodiments of the invention described illustrate a composition fired to achieve the combination of axial CTE of less than or equal to 6.0×10⁻⁷/° C. (from 23-800° C.), or even less than or equal to 5.0×10⁻⁷/° C. (from 23-800° C.), and in some embodiments less than or equal to 4.0×10⁻⁷/° C. (from 23-800° C.), and % P>45%, more specifically, 48%<% P<54%, or even 50%<% P<54%. A moderately narrow small size distribution is achieved having d_{f}, defined as (d₅₀−d₁₀)/d₅₀, of less than 0.65. The d_{f} for the inventive filter examples of Table 4 are between 0.40≦d_{f}≦0.60; or even d_{f}≦0.55; or even 0.50≦d_{f}≦0.60. The examples also preferably exhibit moderately narrow overall pore size distribution by exhibiting narrow d_{b}, defined as (d₉₀−d₁₀)/d₅₀, wherein d_{b} is less than or equal to 2.3; or even less than or equal to 1.9. Examples exhibit reasonable strength with MOR values of greater than or equal to 450 psi, measured as described above. As should be recognized, the examples of Table 5 also achieve moderately narrow pore size distribution thereby providing low washcoated pressure drop for the filter while achieving good filtration efficiency and thermal shock properties. In particular, the pore size distribution is controlled so that greater than 15% and less than 25% (or even less than 20%) of the total porosity exhibit pore diameters of less than 10 μm.

TABLE 5
Inventive Example Properties (Ex. 4-8)

| InventiveExample # | 4 | 5 | 6 | 7 | 8 |
|---|---|---|---|---|---|
| Composition | B | B | B | B | B |
| Firing Schedule | 2 | 2 | 2 | 2 | 2 |
| Axial CTE (10⁻⁷/° C.) | 4.8 | 4.6 | 4.3 | 4.6 | 3.9 |
| (23-800° C.) | | | | | |
| % P | 53.0 | 52.8 | 52.7 | 51.3 | 52.0 |
| d_{f} = (d_{50 -} d₁₀)/d₅₀ | 0.52 | 0.53 | 0.53 | 0.51 | 0.52 |
| d_{b} = (d₉₀ − d₁₀)/d₅₀ | 1.82 | 1.43 | 1.28 | 1.42 | 1.36 |
| MOR (psi) | 291 | 298 | 289 | 275 | 253 |
| eMOD (10⁶ psi) @ 23° C. | 0.62 | 0.63 | 0.65 | 0.62 | 0.63 |

Pore Size Distribution (μm)

| | | | | | |
|---|---|---|---|---|---|
| Total Intrusion | 0.4273 | 0.4271 | 0.4274 | 0.4091 | 0.4138 |
| d₁ (μm) | 2.42 | 2.46 | 2.68 | 1.66 | 0.03 |
| d₂ (μm) | 3.95 | 3.93 | 4.01 | 3.83 | 2.00 |
| d₄ (μm) | 5.12 | 5.27 | 5.13 | 5.34 | 4.94 |
| d₅ (μm) | 5.58 | 5.79 | 5.67 | 5.90 | 5.54 |
| d₁₀ (μm) | 7.54 | 7.71 | 7.53 | 7.74 | 7.40 |
| d₂₅ (μm) | 11.19 | 11.48 | 11.54 | 11.71 | 11.13 |
| d₅₀ (μm) | 15.71 | 16.25 | 16.16 | 15.97 | 15.58 |
| d₇₅ (μm) | 20.75 | 21.68 | 20.31 | 20.25 | 19.82 |
| d₉₀ (μm) | 36.19 | 31.01 | 28.29 | 30.46 | 28.66 |

Pore Size Distribution (%)

| | | | | | |
|---|---|---|---|---|---|
| <10 μm | 18.5 | 17.3 | 18.6 | 17.7 | 19.8 |
| >25 μm | 79.1 | 83.7 | 86.6 | 85.2 | 86.6 |
| >30 μm | 84.0 | 89.4 | 91.2 | 89.8 | 90.9 |

Accordingly, it should be recognized that the embodiments of the invention described in Table 5 illustrate compositions fired to achieve the combination of axial CTE of less than or equal to 6.0×10⁻⁷/° C. (23-800° C.), and % P>45%, more specifically, 48%<% P<54%, or even 50%<% P<54%. d_{f} defined as (d₅₀−d₁₀)/d₅₀ is less than or equal to 0.65. The d_{f} for the inventive filter examples of Table 5 are between 0.40≦d_{f}≦0.65; or even d_{f}≦0.55; or even 0.45≦d_{f}≦0.55. These examples illustrate d₅₀ of the pore size distribution wherein 15.0 μm≦d₅₀≦17.5 μm. The examples also preferably exhibit moderately narrow overall pore size distribution by exhibiting narrow d_{b} defined as (d₉₀−d₁₀)/d₅₀ wherein d_{b} is less than or equal to 1.5. Examples exhibit reasonable strength with MOR values of greater than 250 psi, measured as described above. As should be recognized, the examples of Table 5 also achieve moderately narrow pore size distribution thereby providing low washcoated pressure drop for the filter and achieving good filtration efficiency. In particular, the pore size distribution has greater than 15% and less than 30%, or less than 25%, or even less than 25%, of the total porosity having pores less than 10 μm. According to certain embodiments, greater than or equal to 17% and less than or equal to 22% of the total porosity have pore diameters less than 10 μm. d₉₀ may be ≦32 μm.

Certain exemplary embodiments achieve combinations of properties exceedingly useful for diesel exhaust filtration, such as CTE of less than or equal to 5.0×10⁻⁷/° C. (from 23-800° C.), % P>45%, d_{f}, defined as (d₅₀−d₁₀)/d₅₀, less than 0.55, d_{b}, defined as (d₉₀−d₁₀)/d₅₀, less than or equal to 1.5, and greater than or equal to 17% and less than or equal to 22% of the total porosity have pore diameters less than 10 μm. d₉₀ may be ≦32 μm.

It should also be understood that while the present invention has been described in detail with respect to certain illustrative and specific embodiments thereof, it should not be considered limited to such, as numerous modifications are possible without departing from the broad scope of the present invention as defined in the appended claims.

1-30. (canceled)

31. A method of manufacturing a porous ceramic honeycomb article, comprising the steps of:
providing a plasticized cordierite precursor batch composition containing:
inorganic batch components selected from a magnesium oxide-forming source; an alumina-forming source; and a silica-forming source;
a graphite pore former having a median particle diameter less than 50 μm;
a liquid vehicle; and
a binder;
forming a honeycomb green body from the plasticized cordierite precursor batch composition; and
firing the honeycomb green body under conditions effective to convert the honeycomb green body into the ceramic honeycomb article containing cordierite including
a total porosity greater than 45%,
a coefficient of thermal expansion (CTE) wherein CTE≦6.0×10⁻⁷/° C. (from 23° C. to 800° C.), and
a pore size distribution wherein greater than 15% and less than 38% of the total porosity has a pore diameter less than 10 μm.

32. The method of claim 31 wherein the graphite pore former is present in an amount of from 10 wt. % to 30 wt. % relative to the total weight of the inorganic batch components.

33. The method of claim 31 wherein the pore former comprises graphite having a median particle diameter in the range of from 15 μm to 45 μm.

34. The method of claim 31 wherein the effective firing conditions comprise firing the honeycomb green body at a maximum soak temperature in range of from 1350° C. to 1450° C. and subsequently holding the maximum soak temperature for a period of time sufficient to convert the honeycomb green body into the ceramic honeycomb article containing cordierite.

35. A method of manufacturing a ceramic honeycomb article, comprising the steps of:
providing a honeycomb green body having a batch composition containing inorganic batch components selected from a magnesium oxide source, an alumina-forming source, and a silica-forming source, and a pore former; and
firing the honeycomb green body under firing conditions effective to convert the honeycomb green body into a porous ceramic honeycomb article having a porosity greater than 45% wherein said firing conditions include an upper temperature region between 1100° C. and 1400° C. and an average ramp rate across the upper temperature region is greater than 20° C./hr.

36. The method of claim 35 wherein the average ramp rate across the upper temperature region is greater than 25° C./hr.

37. The method of claim 35 wherein the average ramp rate across the upper temperature region is greater than 30° C./hr.

38. The method of claim 35 wherein the step of firing the honeycomb green body further comprises a hold in a lower temperature region between 180° C. and 400° C. for a time sufficient to substantially completely burn out a binder in the batch composition.

39. The method of claim 35 wherein the step of firing the honeycomb green body further comprises an intermediate temperature region between 400° C. and 1100° C. wherein an average ramp rate across the intermediate temperature region is greater than 10° C./hr and less than 15° C./hr.

40. The method of claim 35 wherein the step of firing further comprises firing the honeycomb green body at a maximum soak temperature in top temperature region of from 1350° C. to 1450° C. and subsequently holding the maximum soak temperature for a period of time sufficient to convert the honeycomb green body into the ceramic honeycomb article containing cordierite.

41. The method of claim 35 wherein the pore former comprises graphite having a median particle diameter less than 50 μm.

42. The method of claim 35 wherein the porous ceramic honeycomb article containing cordierite includes:
total porosity greater than 45%,
coefficient of thermal expansion (CTE) wherein CTE≦6.0×10⁻⁷/° C. (from 23° C. to 800° C.), and
a pore size distribution wherein greater than 15% and less than 38% of the total porosity has a pore diameter of less than 10 μm.
